(19) United States
(12) Patent Application Publication
(10) Pub. No.: US 2019/0196265 A1
(43) Pub. Date: Jun. 27, 2019

(54) DISPLAY DEVICE

(71) Applicant: SHARP KABUSHIKI KAISHA, Sakai City (JP)

(72) Inventor: TOSHIAKI FUJIHARA, Sakai City (JP)

(21) Appl. No.: 16/231,565

(22) Filed: Dec. 23, 2018

(30) Foreign Application Priority Data
Dec. 27, 2017 (JP) 2017-251142

(51) Int. Cl. G02F 1/1335; G02F 1/1333; G02F 1/1339

(52) U.S. Cl. CPC G02F 1/133528; G02F 1/1339; G02F 1/133512; G02F 1/13338

(57) ABSTRACT

A display device includes a display panel for display images, a polarizing plate fixed to the display panel, a protective panel, a structural member, and a light transmissive fixing layer. The protective panel is disposed such that the polarizing plate is sandwiched between the display panel and the protective panel. The structural member projects from a plate surface of the protective panel on a polarizing plate side and overlaps the polarizing plate. The light transmissive fixing layer is disposed between the polarizing plate and the protective panel to fix the polarizing plate and the protective panel together. The light transmissive fixing layer is separated from the structural member with a clearance.

### CROSS REFERENCE TO RELATED APPLICATION

This application claims priority from Japanese Patent Application No. 2017-251142 filed on Dec. 27, 2017. The entire contents of the priority application are incorporated herein by reference.

### TECHNICAL FIELD

The technology described herein relates to a display device.

### BACKGROUND

A known display device includes a first substrate, a second substrate, a liquid crystal display panel, and a transparent cover. The second substrate is disposed closer to a viewer in comparison to the first substrate. The liquid crystal display panel includes a liquid crystal layer sandwiched between the first substrate and the second substrate. The transparent cover is attached to a surface of the liquid crystal display panel closer to the viewer with an adhesive. The liquid crystal display panel includes a polarizing plate disposed between the second substrate and the transparent cover. The adhesive covers entire side surfaces of the polarizing plate. The adhesive has a wavy outline when viewed in plan. An example of such a display is disclosed in Japanese Unexamined Patent Application Publication No. 2009-69321.

The adhesive includes a section that project from the perimeter of the polarizing plate. A dimension of the section in a projecting direction is 0.1 mm or greater. This technology is for reducing display unevenness resulting from expansion of edge sections of the polarizing plate due to moisture. When light sources or other heat generating components generates heat after the liquid crystal display device is turned on, components of the liquid crystal display device may thermally expand. When the liquid crystal display device is turned off, the components may thermally contract. The substrates and the transparent cover included in a liquid crystal panel that is a relatively large component may thermally expand or contract in relatively large amount. If linear expansion coefficients of the substrates and the transparent cover that are disposed on top of each other are different from one another, stresses may be exerted on the substrates and the transparent cover. If the stresses are exerted on certain areas of the liquid crystal panel, display defects may be created in those areas.

### SUMMARY

The technology described herein was made in view of the above circumstances. An object is to reduce display defects.

A display device includes a display panel for display images, a polarizing plate fixed to the display panel, a protective panel, a structural member, and a light transmissive fixing layer. The protective panel is disposed such that the polarizing plate is sandwiched between the display panel and the protective panel. The structural member projects from a plate surface of the protective panel on a polarizing plate side and overlaps the polarizing plate. The light transmissive fixing layer is disposed between the polarizing plate and the protective panel to fix the polarizing plate and the protective panel together. The light transmissive fixing layer is separated from the structural member with a clearance.

According to the configuration light exiting from the display panel is polarized by the polarizing plate. The polarized light passes through the light transmissive fixing layer and the protective panel and then exits the display device. The polarizing plate is protected by the protective panel and fixed to the protective panel with the light transmissive fixing layer. The structural member projects from the plate surface of the protective panel on the polarizing plate side and overlaps the polarizing plate. Therefore, a surface of the display panel is not directly viewed when the display device is viewed from the front side. This configuration provides higher quality of appearance.

The display panel, the polarizing plate, the light transmissive fixing layer, and the protective panel may be thermally expanded or thermally contracted according to variations in thermal condition. Amounts of the thermal expansion and thermal contraction depend on linear expansion coefficients of the display panel, the polarizing plate, the light transmissive fixing layer, and the protective panel. The structural member projects from the plate surface of the protective panel and overlaps the polarizing plate. If the light transmissive fixing layer extends to a space between the structural member and the polarizing plate, a step may be formed in the light transmissive fixing layer. A large amount of stress may be exerted on a section of the display panel closer to the space between the structural member and the polarizing plate. As a result, display defects may be created. Because the light transmissive fixing layer is disposed such that the clearance is provided between the structural member and the light transmissive fixing layer, the light transmissive fixing layer is less likely to be disposed between the structural member and the polarizing plate. The light transmissive fixing layer is less likely to have the step. The stress is less likely to be exerted on the section of the display panel closer to the space between the structural member and the polarizing plate. Therefore, the display defects are less likely to be created.

According to the technology described herein, display defects are less likely to be created.

### BRIEF DESCRIPTION OF THE DRAWINGS

FIG. 1 is a plan view of q liquid crystal display device according to a first embodiment.

FIG. 2 is a cross-sectional view of FIG. 1 along line A-A.

FIG. 3 is a cross-sectional view of FIG. 1 along line B-B.

FIG. 4 is a plan view illustrating a touch panel pattern on a cover glass included in a liquid crystal display device according to a second embodiment.

FIG. 5 is a magnified plan view illustrating a section of the touch panel pattern closer to a corner of the cover glass.

FIG. 6 is a cross-sectional view of a liquid crystal display device along a long dimension of the liquid crystal display device.

FIG. 7 is a cross-sectional view of the liquid crystal display device along a short dimension of the liquid crystal display device.

### DETAILED DESCRIPTION

### First Embodiments

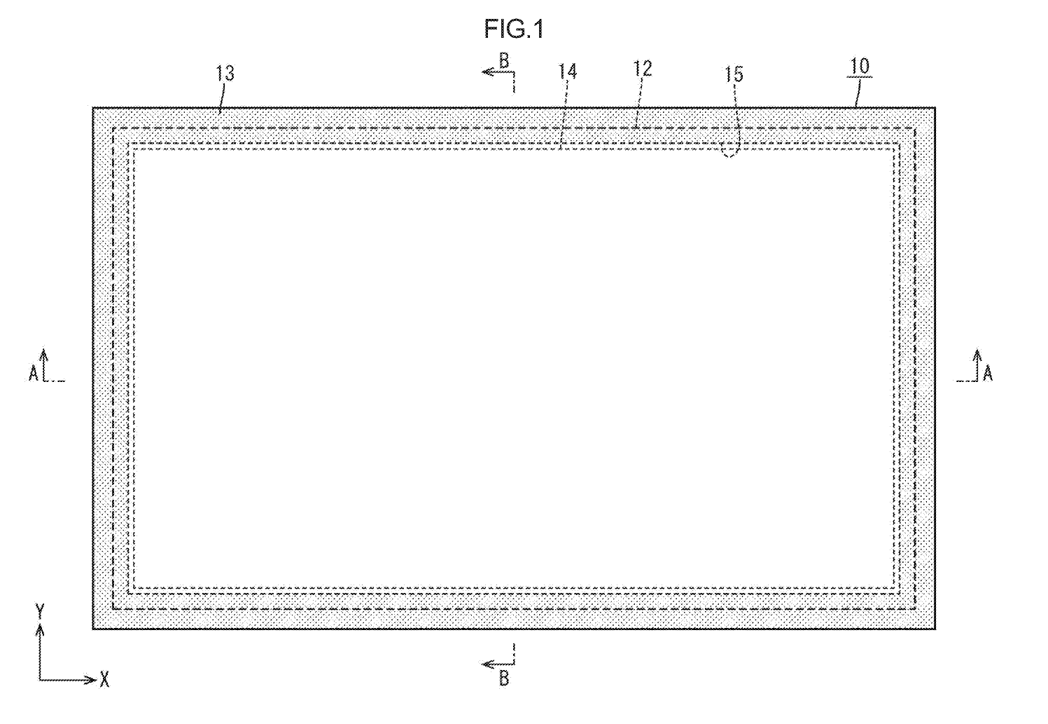

A first embodiment will be described with reference to FIGS. 1 to 3. In this section, a liquid crystal display device 10 will be described. The X axes, the Y axes, and the Z axes may be present in the drawings. The axes in each drawing correspond to the respective axes in other drawings to indicate the respective directions. An upper side and a lower side in each drawing correspond to a front side and a back side of the liquid crystal display device 10, respectively.

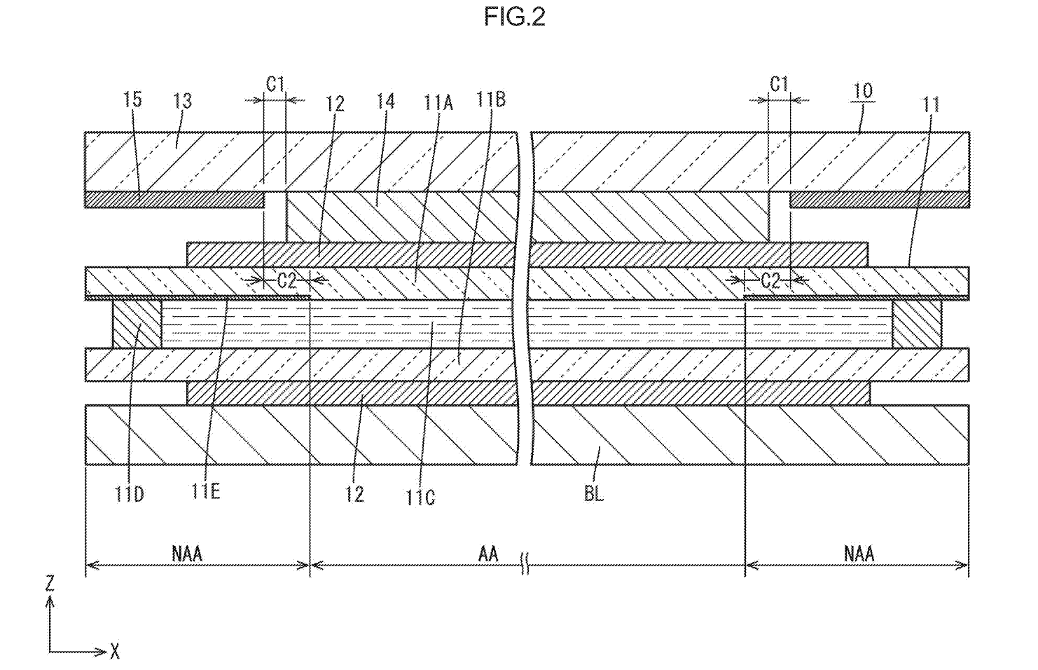

As illustrated in FIG. 1, the liquid crystal display device 10 has a horizontally-long rectangular shape with a long direction and a short direction corresponding with the X-axis direction and the Y-axis direction. As illustrated in FIG. 2, the liquid crystal display device 10 includes a liquid crystal panel 11 (a display panel), front and back polarizing plates 12 (polarizing plates with retardation functions), a cover glass 13 (a protective panel), a light transmissive fixing layer 14, and a backlight unit BL. The liquid crystal panel 11 is configured to display images. The front polarizing plate 12 and the back polarizing plate 12 are attached to front and back plate surfaces of the liquid crystal panel 11, respectively. The cover glass 13 is disposed to cover the front polarizing plate 12 from the front side. The light transmissive fixing layer 14 is disposed between the front polarizing plate 12 and the cover glass 13 and fixed to the front polarizing plate 12 and the cover glass 13. The backlight unit BL is an external light source disposed behind and opposite the liquid crystal panel 11 (on an opposite side from the cover glass 13) for supplying light to the liquid crystal panel 11 for image display.

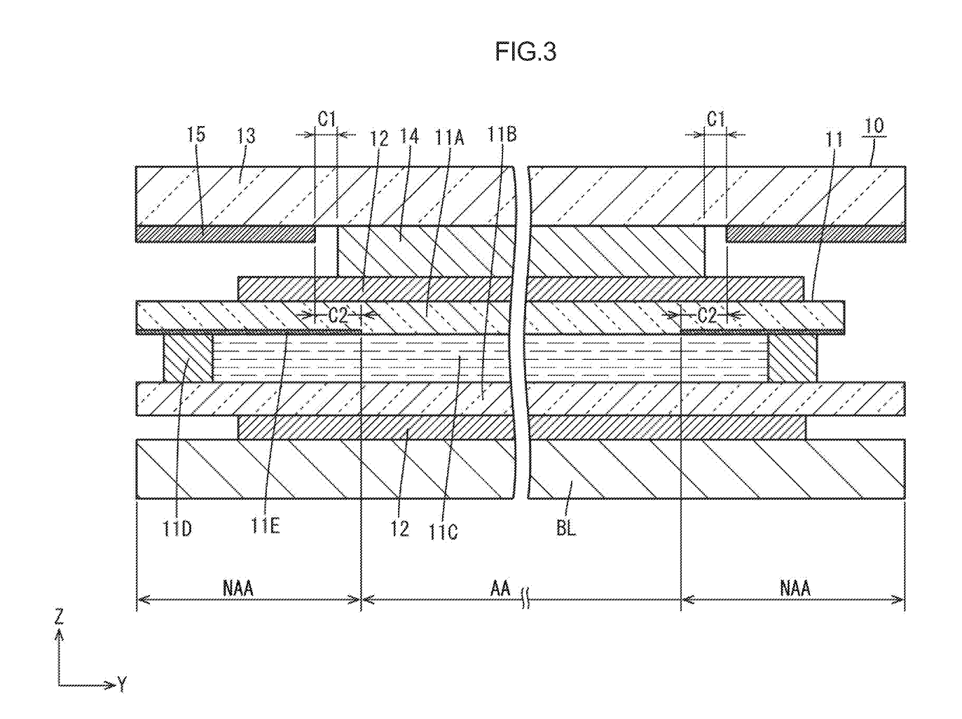

As illustrated in FIGS. 2 and 3, the liquid crystal panel 11 includes substrates 11A and 11B, a liquid crystal layer 11C, and a sealant 11D. The substrates 11A and 11B are opposed to each other with a gap (a cell gap) and bonded together. The liquid crystal layer 11C is sandwiched between the substrates 11A and 11B. The sealant 11D is disposed between outer edge sections of the substrates 11A and 11B to surround and to seal the liquid crystal layer 11C. The liquid crystal panel 11 is configured to operate in in-plane switching (IPS) mode in which liquid crystal molecules in the liquid crystal layer are horizontally oriented. The substrates 11A and 11B are substantially transparent and made of glass (e.g., alkali-free glass). The substrates 11A and 11B have linear expansion coefficients less than a linear expansion coefficient of the cover glass 13. One of the substrates 11A and 11B disposed on the back side is an array substrate 11B (an active matrix substrate). The array substrate 11B includes source lines, gate lines, switching components (e.g., TFTs), pixel electrodes, and an alignment film. The switching components are connected to the source lines and the gate lines that are perpendicular to each other. The pixel electrodes are connected to the switching components. The substrate 11A on the front side is a CF substrate 11A (a common substrate). The CF substrate 11A includes a color filter, a light blocking portion (a black matrix, a display panel-side light blocking portion), and an alignment film. The color filter includes red (R), green (G) and blue (B) color portions that are disposed in a predefined arrangement. The light blocking portion separates the adjacent color portions from one another. The light blocking portion includes a grid section that separates the adjacent color portions from one another and a frame section 11E that extends for an entire perimeter of the CF substrate 11A. The liquid crystal panel 11 includes a display area (an active matrix area) AA in which images are displayed and a non-display area (a non-active area) NAA having a frame shape to surround the display area AA and in which images are not displayed. The frame section 11E surrounds the display area AA to define the display area AA. The frame section 11E is disposed to about entirely cover the non-display area NAA.

As illustrated in FIGS. 2 and 3, the front and the back polarizing plates 12 are disposed to cover the entire display area AA (or a section of the light blocking portion other than the frame section 11E) and a section of the non-display area NAA around an inner perimeter of the non-display area NAA (the frame section 11E). The front and the back polarizing plates 12 include plate surfaces along the plate surface of the liquid crystal panel 11. The front and the back polarizing plates 12 include polarizing layers for creating linearly polarized light from ambient light. Each polarizing layer includes a polarizer and protective films that sandwich the polarizer. The polarizer is prepared by mixing absorbers such as iodine and dichromatic dyes into a polymer resin film such as polyvinyl alcohol (PVA) film and stretching in one direction to orient the absorbers. The protective films may be triacetylcellulose (TAC) films. The front and the back polarizing plates 12 include retardation layers (retarders) for creating phase differences in transmitting light. Each retardation layer is prepared by uniaxially or biaxially stretching a polymer resin film. The retardation layers create phase differences in transmitting light to compensate degradation in view angle characteristics due to birefringence of the liquid crystal layer. The front and the back polarizing plates 12 have such retardation functions. The front and the back polarizing plates 12 include laminator layers (protective layers) for protecting the polarizing layers and fixing layers fixed to the plate surfaces of the CF substrate 11A and the array substrate 11B.

As illustrated in FIG. 1, the cover glass 13 has a horizontally-long rectangular shape for covering about entire areas of the liquid crystal panel 11 and the front polarizing plate 12 from the front side. The liquid crystal panel 11 and the front polarizing plate 12 are protected by the cover glass 13. As illustrated in FIGS. 2 and 3, the cover glass 13 is opposed to the front plate surface of the front polarizing plate 12 and fixed to the front plate surface of the front polarizing plate 12 with the light transmissive fixing layer 14 that is disposed between the cover glass 13 and the front polarizing plate 12. The light transmissive fixing layer 14 is a substantially transparent adhesive layer having high light transmissivity, such as an optical clear adhesive (OCA) film. The light transmissive fixing layer 14 may be made of ultraviolet curable resin that is cured when an ultraviolet ray is applied. The light transmissive fixing layer 14 will be described in more detail later. A frame-shaped light blocking member 15 (a structural member, a protective panel-side light blocking member) having light blocking properties is disposed on an outer edge section of the cover glass 13. The frame-shaped light blocking member 15 extends for an entire perimeter of the cover glass 13. In FIG. 1, the frame-shaped light blocking member 15 is shaded. The frame-shaped light blocking member 15 is prepared by forming a light blocking film made of light blocking material (e.g., a carbon black and a metal material) on the back plate surface of the cover glass 13. The frame-shaped light blocking member 15 is a structural member that project from the back plate surface of the cover glass 13 toward the back side (toward the front polarizing plate 12) by a thickness of the light blocking film. The frame-shaped light blocking member 15 is disposed over the frame section 11E (the non-display area NAA) in the liquid crystal panel 11 except for the inner edge section. An area surrounded by the frame-shaped light blocking member 15 is slightly larger than the display area AA that is surrounded by the frame section 11E. The cover glass 13 has a plate shape. The cover glass 13 is made of substantially transparent glass having high light transmissivity (e.g., soda lime glass), preferably. A tempered glass, preferably, a chemically tempered glass may be used for the cover glass 13. The chemically tempered glass is prepared by chemical tempering on a surface of a glass plate to form a chemically toughened layer on the surface.

As illustrated in FIGS. 2 and 3, the frame-shaped light blocking member 15 is disposed to overlap the front polarizing plate 12 in a plan view. Specifically, the inner edge section of the frame-shaped light blocking member 15 is disposed to overlap the outer edge section of the front polarizing plate 12 for the entire perimeter of the front polarizing plate 12. When the liquid crystal display device 10 is viewed from the front side, the surface of the front polarizing plate 12 attached to the surface of the liquid crystal panel 11 and the surf ace of the frame-shaped light blocking member 15 on the surface of the cover glass 13 may be viewed; however, the surface of the liquid crystal panel 11 may not be directly viewed. In comparison to a configuration in which the frame-shaped light blocking member does not overlap the front polarizing plate 12 and the surface of the liquid crystal panel 11 is directly viewed from the front side, the liquid crystal display device 10 according to this embodiment has higher quality of appearance. Because the frame-shaped light blocking member 15 has the light blocking properties, light rays passed through the outer edge section of the front polarizing plate 12 are blocked by the frame-shaped light blocking member 15. The outer edge section of the front polarizing plate 12 overlaps the non-display area NAA. Transmitting light through the outer edge section of the front polarizing plate 12 is referred to as leak light that is not used for the image display in the display area AA. By blocking the transmitting light through the outer edge section of the front polarizing plate 12 with the frame-shaped light blocking member 15, the lead light does not exit the liquid crystal display device 10 and thus display quality improves. The frame-shaped light blocking member 15 is disposed so that inner edge of the frame-shaped light blocking member 15 is inner than the inner edge of the sealant 11D.

As illustrated in FIGS. 2 and 3, the liquid crystal panel 11, the polarizing plate 12, the light transmissive fixing layer 14, and the cover glass 13 that are disposed on top of one another may thermally expand or thermally contract according to variations in thermal condition. Amounts of the thermal expansion and thermal contraction depend on the linear expansion coefficients of the liquid crystal panel 11, the polarizing plate 12, the light transmissive fixing layer 14, and the cover glass 13. The frame-shaped light blocking member 15 projects from the back plate surface of the cover glass 13 and overlaps the front polarizing plate 12. If the light transmissive fixing layer 14 extends to a space between the frame-shaped light blocking member 15 and the front polarizing plate 12, a step is formed in the light transmissive fixing layer 14. A large amount of stress may be applied to a section of the liquid crystal panel 11 closer to the space between the frame-shaped light blocking member 15 and the front polarizing plate 12. The inner edge of the sealant 11D is located outer than the inner edge of the frame-shaped light blocking member 15. A large amount of stress that is exerted on the section of the liquid crystal panel 11 closer to the space between the frame-shaped light blocking member 15 and the front polarizing plate 12 may create a difference in thickness of the liquid crystal layer 11C. If the thickness becomes uneven, display defects may be created. To solve such a problem, the light transmissive fixing layer 14 is disposed away from the frame-shaped light blocking member 15 with a clearance C1. Namely, the light transmissive fixing layer 14 is not disposed in the space between the frame-shaped light blocking member 15 and the front polarizing plate 12. Therefore, the light transmissive fixing layer 14 does not have a step that may be created by the frame-shaped light blocking member 15 and thus a stress is less likely to be exerted on the section of the liquid crystal panel 11 closer to the space between the frame-shaped light blocking member 15 and the front polarizing plate 12. The difference in thickness of the liquid crystal layer 11C is less likely to be created and thus the display defects are less likely to be created. If the difference in thickness of the liquid crystal layer 11C is created due to the stress, color unevenness may be observed in specific areas because the front polarizing plate 12 in this embodiment has the retardation function. In this Embodiment, such color unevenness is less likely to occur and thus high display quality can be achieved.

As illustrated in FIGS. 2 and 3, the light transmissive fixing layer 14 is disposed such that the clearance C1 between the frame-shaped light blocking member 15 and the light transmissive fixing layer 14 is 0.1 mm or greater. In a production of the liquid crystal display device 10, the polarizing plate 12 is attached to the liquid crystal panel 11 and the light transmissive fixing layer 14 is fixed to one of the front polarizing plate 12 and the cover glass 13. Then, the light transmissive fixing layer 14 is fixed to the other one of the front polarizing plate 12 and the cover glass 13 and the light transmissive fixing layer 14 is cured. To fix the light transmissive fixing layer 14 to the cover glass 13, the light transmissive fixing layer 14 is positioned relative to the frame-shaped light blocking member 15. However, a positioning error may occur. If the clearance C1 between the light transmissive fixing layer 14 and the frame-shaped light blocking member 15 is less than 0.1 mm and the positioning error occurs, the light transmissive fixing layer 14 is more likely to contact the frame-shaped light blocking member 15. In this embodiment, the clearance C1 between the light transmissive fixing layer 14 and the frame-shaped light blocking member 15 is 0.1 mm or greater. Namely, a sufficient size of the clearance C1 is provided so that the light transmissive fixing layer 14 is less likely to contact the frame-shaped light blocking member 15 even if the positioning error occurs.

As illustrated in FIGS. 2 and 3, the light transmissive fixing layer 14 is disposed such that the outer edges of the light transmissive fixing layer 14 are inner than the inner edges of the frame-shaped light blocking member 15. Namely, the light transmissive fixing layer 14 is disposed not to overlap the frame-shaped light blocking member 15. In comparison to a configuration in which the light transmissive fixing layer 14 is disposed to overlap the frame-shaped light blocking member 15, the clearance C1 is properly provided between the light transmissive fixing layer 14 and the frame-shaped light blocking member 15. The outer edges of the light transmissive fixing layer 14 are located outer than the inner edges of the frame portion 11E (a boundary between the display area AA and the non-display area) for the entire perimeter of the light transmissive fixing layer 14. The light transmissive fixing layer 14 is disposed such that the clearance C1 between the light transmissive fixing layer 14 and the frame-shaped light blocking member 15 is less than a distance C2 between the frame-shaped light blocking member 15 and the display area AA. According to the configuration, the light transmissive fixing layer 14 covers the entire display area AA. Namely, the outer edge section (a section) of the display area AA constantly overlaps the light transmissive fixing layer 14. Therefore, exiting light rays from the display area AA are more likely to pass through the light transmissive fixing layer 14. A problem such that some of the exiting light rays from the display area AA exit without passing through the light transmissive fixing layer 14 is less likely to occur. According to the configuration, display defects are less likely to be created. The light transmissive fixing layer 14 is disposed such that a difference between the clearance C1 and the distance C2 is 0.1 mm or greater. If the difference is less than 0.1 mm, the outer edge section of the display area may not constantly overlap the light transmissive fixing layer 14 due to the positioning error that may occur in the positioning of the light transmissive fixing layer 14 relative to the front polarizing plate 12. With the clearance C1 defined such that the difference between the clearance C1 and the distance C2 is 0.1 mm or greater, the light transmissive fixing layer 14 more properly covers the entire display area AA even if the positioning error occurs. Therefore, the section of the display area AA constantly overlaps the light transmissive fixing layer 14. The display defects are further less likely to be created.

As illustrated in FIGS. 1 and 2, the long-side inner edge sections and the short-side inner edge sections of the frame-shaped light blocking member 15 overlap the long-side outer edge sections and the short-side inner edge sections of the front polarizing plate 12, respectively. The clearance C1 between the short-side outer edge sections of the transmissive fixing layer 14 and the short-side inner edge sections of the frame-shaped light blocking member 15 is 0.1 mm or greater. The short-side inner edge sections of the frame-shaped light blocking member 15 are located closer to the ends of the front polarizing plate 12 and the cover glass 13 with respect to the X-axis direction (the longitudinal direction, the long direction) in which the amounts of expansion and contraction of the front polarizing plate 12 and the cover glass 13 due to variations in the thermal conditions are especially large. Large amounts of stresses may be exerted on the section of the liquid crystal panel 11 in which the short-side inner edge sections of the frame-shaped light blocking member 15 and the short-side outer edge sections of the front polarizing plate 12 overlap each other. In this embodiment, the stresses are effectively compensated because the clearance C1 that is equal to 0.1 mm or greater is provided between the short-side outer edge sections of the light transmissive fixing layer 14 and the short-side inner edge sections of the frame-shaped light blocking member 15. Furthermore, as illustrated in FIGS. 1 and 3, the clearance C1 of 0.1 mm or greater is provided between the long-side outer edge sections of the light transmissive fixing layer 14 and the long-side inner edge sections of the frame-shaped light blocking member 15. Stresses that may be exerted on the outer edge section of the liquid crystal panel 11 are properly compensated for the entire perimeter of the liquid crystal panel 11. Therefore, a frame-shaped display defect is less likely to be created on the liquid crystal panel 11.

As described above, the liquid crystal display device 10 includes the liquid crystal panel 11, the front and the back polarizing plates 12, the cover glass 13, the light transmissive fixing layer 14, and the frame-shaped light blocking member 15. The liquid crystal panel 11 is configured to display images. The front and the back polarizing plates 12 are fixed to the liquid crystal panel 11. The cover glass 13 is disposed such the front polarizing plate 12 is between the liquid crystal panel 11 and the cover glass 13. The frame-shaped light blocking member 15 is a structural member disposed to project from the plate surface of the cover glass 13 on the front polarizing plate 12 side and to overlap the front polarizing plate 12. The light transmissive fixing layer 14 is disposed between the front polarizing plate 12 and the cover glass 13 and fixed to the front polarizing plate 12 and the cover glass 13. The light transmissive fixing layer 14 is disposed with the clearance C1 between the frame-shaped light blocking member 15 and the light transmissive fixing layer 14.

The light exiting from the liquid crystal panel 11 is polarized when the light passes through the front polarizing plate 12. The light from the front polarizing plate 12 passes through the light transmissive fixing layer 14 and the cover glass 13, and then the light exits to the outside. The front polarizing plate 12 is protected by the cover glass 13. The front polarizing plate 12 is fixed to the cover glass 13 with the light transmissive fixing layer 14. The frame-shaped light blocking member 15, which is a structural member, projects from the plate surface of the cover glass 13 on the front polarizing plate 12 side. The frame-shaped light blocking member 15 is disposed to overlap the front polarizing plate 12. Therefore, the surface of the liquid crystal panel 11 is not directly viewed when the liquid crystal display device 10 is viewed from the front side. This configuration provides higher quality of appearance.

The liquid crystal panel 11, the polarizing plate 12, the light transmissive fixing layer 14, and the cover glass 13 may be thermally expanded or thermally contracted according to variations in thermal condition. The amounts of the thermal expansion and thermal contraction depend on the linear expansion coefficients of the liquid crystal panel 11, the polarizing plate 12, the light transmissive fixing layer 14, and the cover glass 13. The frame-shaped light blocking member 15 projects from the back plate surface of the cover glass 13 and overlaps the front polarizing plate 12. If the light transmissive fixing layer 14 extends to a space between the frame-shaped light blocking member 15 and the front polarizing plate 12, a step is formed in the light transmissive fixing layer 14. A large amount of stress may be exerted on a section of the liquid crystal panel 11 closer to the space between the frame-shaped light blocking member 15 and the front polarizing plate 12. As a result, display defects may be created. In this embodiment, the light transmissive fixing layer 14 is disposed such that the clearance C1 is provided between the frame-shaped light blocking member 15 and the light transmissive fixing layer 14. Therefore, the light transmissive fixing layer 14 is less likely to be disposed between the frame-shaped light blocking member 15 and the front polarizing plate 12. The light transmissive fixing layer 14 is less likely to have the step. The stress is less likely to be exerted on the section of the liquid crystal panel 11 closer to the space between the frame-shaped light blocking member 15 and the front polarizing plate 12. Therefore, the display defects are less likely to be created.

The light transmissive fixing layer 14 is disposed such that the clearance C1 between the frame-shaped light blocking member 15 and the light transmissive fixing layer 14 is 0.1 mm or greater. If the clearance C1 is less than 0.1 mm, the light transmissive fixing layer 14 is more likely to contact the frame-shaped light blocking member 15 due to the positioning error. With the clearance C1 equal to 0.1 mm or greater provided between the light transmissive fixing layer 14 and the frame-shaped light blocking member 15, the light transmissive fixing layer 14 is less likely to contact the frame-shaped light blocking member 15 even if the positioning error occurs.

The light transmissive fixing layer 14 is disposed not to overlap the frame-shaped light blocking member 15. In comparison to a configuration in which the light transmissive fixing layer 14 is disposed to overlap the frame-shaped light blocking member 15, the clearance C1 is properly provided between the light transmissive fixing layer 14 and the frame-shaped light blocking member 15.

The liquid crystal panel 11 includes the display area AA in which images are displayed. The light transmissive fixing layer 14 is disposed such that the clearance C1 between the frame-shaped light blocking member 15 and the light transmissive fixing layer 14 is less than the distance C2 between the frame-shaped light blocking member 15 and the display area AA. According to the configuration, the light transmissive fixing layer 14 is more likely to constantly cover the entire display area AA. Therefore, the rays exiting to the outside without passing through the light transmissive fixing layer 14 are reduced and thus the display defects are further less likely to be created.

The light transmissive fixing layer 14 is disposed such that the difference between the clearance C1 and the distance C2 is equal to or greater than 0.1 mm. Even if the positioning error occurs in the positioning of the light transmissive fixing layer 14, the light transmissive fixing layer 14 is more likely to constantly cover the entire display area AA. Therefore, the display defects are further less likely to be created.

The liquid crystal panel 11 includes the substrates 11A and 11E, the liquid crystal layer 11C, and the sealant 11D. The liquid crystal layer 11C is sandwiched between the substrates 11A and 11B. The sealant 11D is disposed between the substrates 11A and 11B to surround and seal the liquid crystal layer 11C. The sealant 11D is disposed such that the inner edges of the sealant 13 are outer than the inner edges of the frame-shaped light blocking member 15. If a large amount of stress is exerted on the section of the liquid crystal panel 11 closer to the space between the frame-shaped light blocking member 15 and the front polarizing plate 12, the thickness of the liquid crystal layer 11C becomes uneven due to the stress. This may create the display defects. In this embodiment, the light transmissive fixing layer 14 is disposed such that the clearance C1 is provided between the frame-shaped light blocking member 15 and the light transmissive fixing layer 14. The stress is less likely to be exerted on the section of the liquid crystal panel 11 closer to the space between the frame-shaped light blocking member 15 and the front polarizing plate 12. Therefore, the thickness of the liquid crystal layer 11C is more likely to remain even and thus the display defects are less likely to be created.

The liquid crystal panel 11, the front polarizing plate 12, and the cover glass 13 have the rectangular shapes. The frame-shaped light blocking member 15 overlaps at least the edge sections of the front polarizing plate 12 at ends of the long dimension of the front polarizing plate 12. The amounts of expansion and contraction of the liquid crystal panel 11, the front polarizing plate 12, and the cover glass 13 tend to be especially large in the longitudinal direction of the liquid crystal panel 11, the front polarizing plate 12, and the cover glass 13. Therefore, large amounts of stresses may be exerted on sections of the liquid crystal panel 11 closer to spaces between the edge sections of the frame-shaped light blocking member 15 and the front polarizing plate 12. In this embodiment, the clearance C1 is provided between the frame-shaped light blocking member 15 and the light transmissive fixing layer 14. Therefore, the stresses that may be exerted on the sections of the liquid crystal panel 11 closer to the ends of the longitudinal dimension of the liquid crystal panel 11 can be properly compensated. A frame-shaped display defect is less likely to be created on the liquid crystal panel 11.

The frame-shaped light blocking member 15 overlaps the outer edge sections of the front polarizing plate 12 for the entire perimeter of the front polarizing plate 12. According to the configuration, stresses that may be exerted on the outer edge sections of the liquid crystal panel 11 can be properly compensated. Therefore, the frame-shaped display defect is less likely to be created on the liquid crystal panel 11.

The frame-shaped light blocking member 15 is a structural member that has light blocking properties and is disposed in the outer edge sections of the cover glass 13 to extend for the entire perimeter of the cover glass 13. According to the configuration, light rays toward the outer edge sections of the cover glass 13 are blocked by the frame-shaped light blocking member 15 for the entire perimeter of the cover glass 13. Because the frame-shaped light blocking member 15, which is the structural member having the light blocking properties, is disposed to overlap the front polarizing plate 12, light rays from overlapping sections of the front polarizing plate 12 are less likely to leak to the outside. Therefore, the display quality improves.

The front polarizing plate 12 has the retardation function. The light from the liquid crystal panel 11 is polarized while passing through the front polarizing plate 12 to have the phase difference. This provides view angle compensation. According to the front polarizing plate 12 that has the retardation function, colors of displayed images may be locally different from target colors due to the phase difference and a stress exerted on the liquid crystal panel 11. In this embodiment, the light transmissive fixing layer 14 is disposed away from the frame-shaped light blocking member 15 by the clearance C1. Therefore, the section of the liquid crystal panel closer to the space between the frame-shaped light blocking member 15 and the front polarizing plate 12 and thus local color unevenness is less likely to occur on the liquid crystal panel 11.

### Second Embodiment

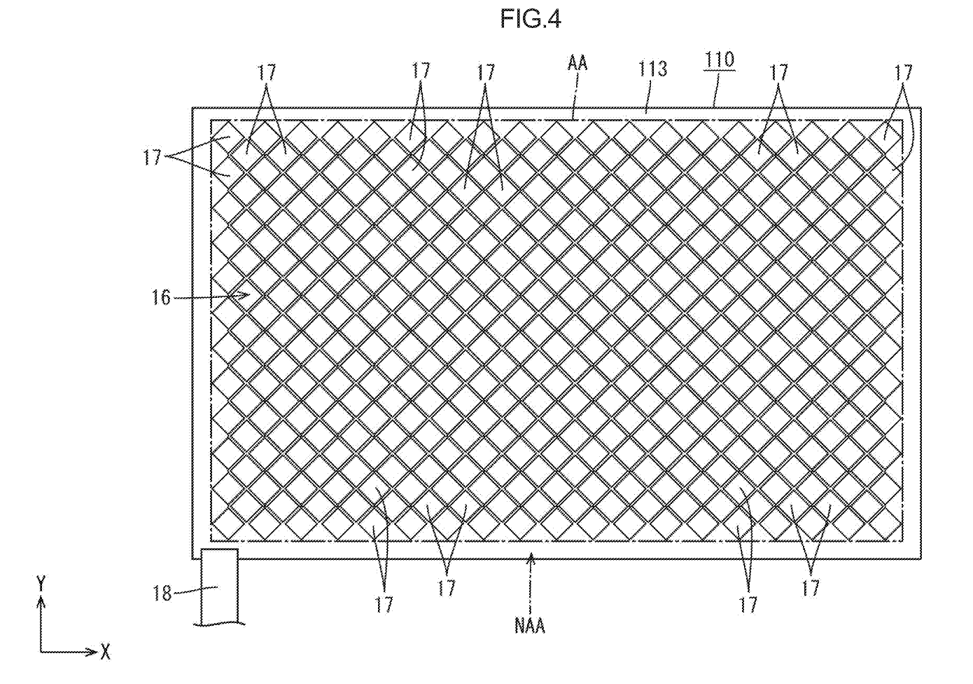

A second embodiment will be described with reference to FIGS. 4 to 7. The second embodiment includes a cover glass 113 having a configuration different from the configuration of the cover glass 13 in the first embodiment. Configuration, functions, and effects similar to those of the first embodiment will not be described.

As illustrated in FIG. 4, the cover glass 113 includes a touch panel pattern 16 for detecting input positions at which a user of a liquid crystal display device 110 inputs positional information in response to images displayed in the display area AA of a liquid crystal panel 111. The touch panel pattern 16 is a projected capacitive type touch panel pattern. The detection uses a self-capacitance detection technology. The touch panel pattern 16 is prepared by forming a transparent electrode film on a back plate surface of the cover glass 113 and patterning the transparent electrode film. The touch panel pattern 16 includes touch electrodes 17 (position detection electrodes) arranged in a matrix that includes lines of the touch electrodes 17 in the X-axis direction and lines of the touch electrodes 17 in the Y-axis direction within the display area AA of the liquid crystal panel 111. The touch electrodes 17 are disposed in an area of the cover glass 113 overlapping the display area AA of the liquid crystal panel 11. The area of the cover glass 113 may be referred to as a touch area. The display area AA of the liquid crystal panel 111 substantially corresponds with the touch area in which the input positions are detectable. A non-display area NAA of the liquid crystal panel 111 substantially corresponds with non-touch area in which the input positions are not detectable. When a finger of a user, which is a conductive body, is brought closer to a surface of the cover glass 113 for position information input based on an image displayed in the display area AA recognized by the user, a capacitor is formed between the finger and the touch electrode 17. A capacitance detected by the touch electrode 17 closer to the finger alters as the finger approaches the touch electrode 17. The capacitance differs from capacitances detected by the touch electrodes 17 farther from the finger. Based on a difference in capacitance, the input position is detected.

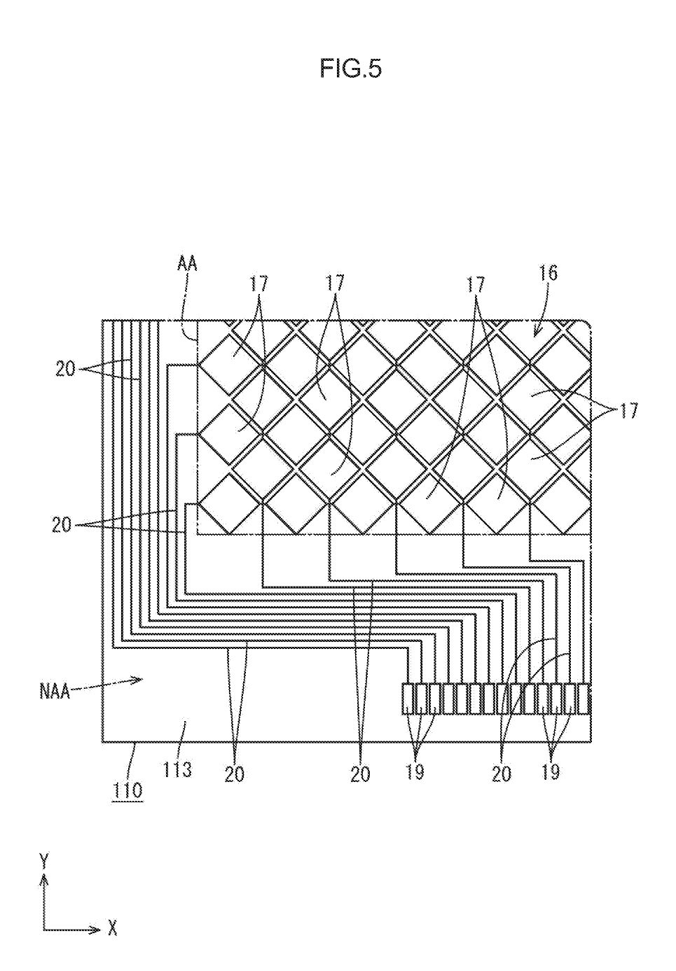

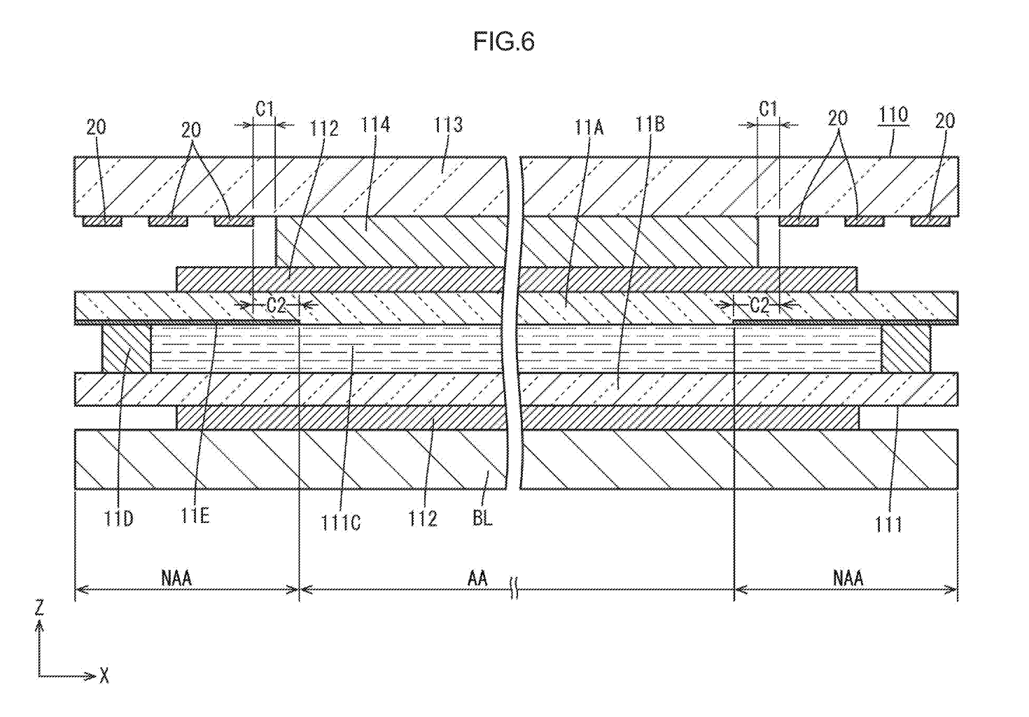

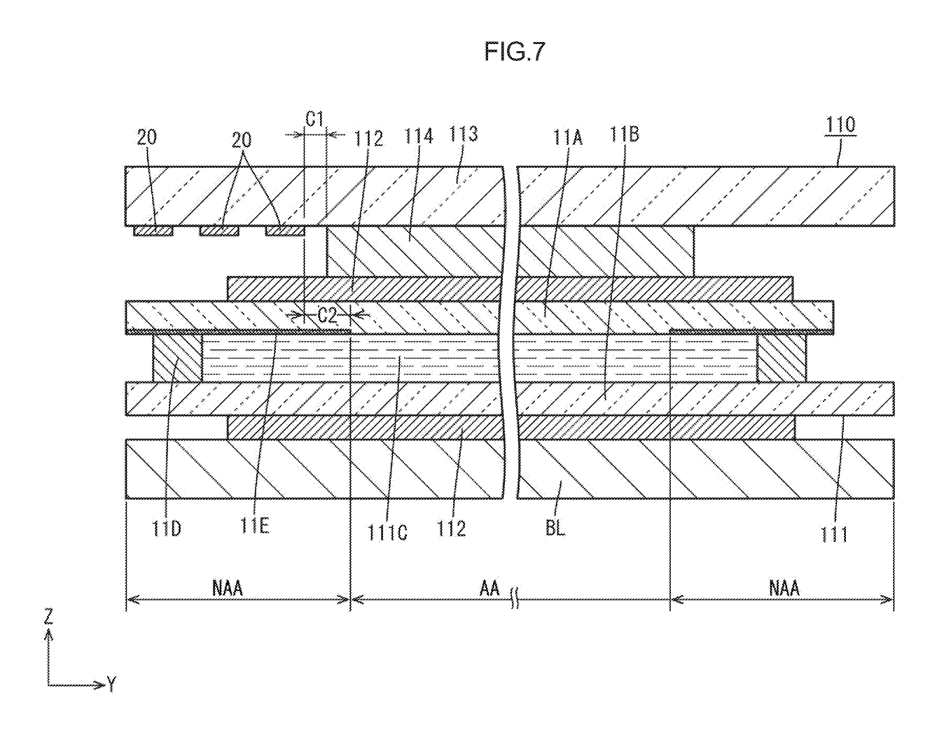

As illustrated in FIG. 4, a flexible circuit board 18 for a touch panel is connected to a corner of the outer edge section of the cover glass 113 (the non-touch area). The flexible circuit board 18 is for transmitting signals from a touch panel control circuit. As illustrated in FIG. 5, the corner of the outer edge section of the cover glass 113 includes terminals 19. The terminals 19 are electrically connected to terminals of the flexible circuit board 18. The outer edge section of the cover glass 113 includes electric lines 20 (a structural member) connected to the terminals 19 and the touch panel pattern 16. The electric lines 20 are routed parallel to each other to surround the touch area (the display area AA) in the outer edge section of the cover glass 113. The electric lines 20 include first ends connected to the terminals 19 and second ends connected to the touch electrodes 17 in the touch panel pattern 16. The electric lines 20 are prepared by forming a transparent electrode film and a metal film on the back plate surface of the cover glass 113 and patterned the transparent electrode film and the metal film. Namely, each electric line 20 has a multilayer structure of the transparent electrode film and the metal film. The electric lines 20 have line resistances less than a line resistance of the touch panel pattern 16 (or the touch electrodes 17), which is prepared from the transparent electrode film. Therefore, sensitivity in position detection can be properly maintained. Each terminal 19 also has a multilayer structure of the transparent electrode film and the metal film. The electric lines 20 are disposed along one of the long edges of the cover glass 113 and the short edges of the cover glass 113 in the outer edge section of the cover glass 113. As illustrated in FIGS. 6 and 7, the electric lines 20 are arranged at intervals in the X-axis direction and the Y-axis direction in the outer edge section of the cover glass 113. The electric lines 20 protrude from the back plate surface of the cover glass 113. The electric lines 20 may be referred to as structural members that protruded from the back plate surface of the cover glass 113 toward the back side (the polarizing plate 112 side) by a thickness of the metal film. Because each electric line 20 has the multilayer structure of the transparent electrode film and the metal film, a dimension of the electric line 20 from the back plate surface of the cover glass 113 is greater than that of the touch panel pattern 16 by the thickness of the metal film.

The innermost electric line 20 (the closest to the display area AA) and the adjacent electric line 20 overlap the outer edge section of the polarizing plate 112 in a plan view. A light transmissive fixing layer 114 is disposed separated from the innermost electric line 20 with the clearance C1 that is equal to 0.1 mm or greater. According to the configuration, the light transmissive fixing layer 114 is less likely to be present between the electric line 20 and the polarizing plate 112. Although the electric line 20 has the multilayer structure and the dimensions from the back plate surface of the cover glass is larger, the light transmissive fixing layer 114 is less likely to have a step resulting from the electric line 20. Therefore, a stress is less likely to be exerted on the section or the liquid crystal panel 111 closer to a space between the electric line 20 and the polarizing plate 112. Because a thickness of a liquid crystal layer 111C is less likely to become uneven due to the stress, the display defects are less likely to be created. The light transmissive fixing layer 114 does not overlap the electric lines 20. Furthermore, the light transmissive fixing layer 114 is separated from the innermost electric line 20 with the clearance C1 that is defined such that a difference between the clearance C1 and the distance C2 between the innermost electric line 20 and the display area AA is 0.1 mm or greater. According to the configuration, even if a positioning error occurs in positioning of the light transmissive fixing layer 114 relative to the polarizing plate 112, the light transmissive fixing layer 114 properly covers the entire display area AA. Namely, non-overlapping section is less likely to be present between the display area AA and the light transmissive fixing layer 114. Therefore, the display defects are further less likely to be created.

As described earlier, the electric lines 20 routed on the cover glass 113 may be referred to as the structural members. The electric lines 20 may be used as a structural member overlapping the polarizing plate 112.

The cover glass 113 includes the touch electrodes 17 (the position detection electrodes) connected to the electric lines 20. The each touch electrode 17 and the finger of the user form a capacitor having a capacitance from which a position of input by the user is detected. The touch electrodes 17 are prepared from the transparent electrode film. Each electric line 20 has the multilayer structure of the transparent electrode film and the metal film. Based on the capacitance between the finger, which is the conductive member for the position information input, and one of the touch electrodes 17 on the cover glass 113, the position of input by the finger or the conductive member can be detected. Each electric line 20 connected to the touch electrodes 17 has the multilayer structure of the transparent electrode film and the metal film. Therefore, the line resistance of the electric line 20 is less than the line resistances of the touch electrodes 17 that are prepared from the transparent electrode film. According to the configuration, the higher sensitively in position detection can be maintained. Each electric line 20 has the dimension from the back plate surface of the cover glass 113 greater than that of the touch electrodes 17. The electric line 20 may create a large step in the light transmissive fixing layer 114. Because the clearance C1 is provided between the light transmissive fixing layer 114 and the electric line 20, the light transmissive fixing layer 114 is less likely to have the step resulting from the electric line 20. Therefore, the stress is less likely to be exerted on the section of the liquid crystal panel 111 closer to the space between the electric line 20 and the polarizing plate 112 and thus the display defects are less likely to be created.

### Other Embodiments

The technology described herein is not limited to the embodiments described above and with reference to the drawings. The following embodiments may be included in the technical scope.

(1) The clearance C1 may be altered where appropriate. The distance C2 may be altered where appropriate. The difference between the clearance C1 and the distance C2 may be altered where appropriate. The clearance C1, the distance C2, and the difference may be defined based on the positioning error. The clearance C1, the distance C2, and the difference may be reduced as the accuracy in positioning increases.

(2) The frame-shaped light blocking member 15 and the light transmissive fixing layer 14 or the electric line 20 and the light transmissive fixing layer 114 may overlap each other as long as they are separated from each other with the clearance C1.

(3) The TAC film included in the polarizing layer may have the retardation function and the retardation layer may be omitted. The configuration of the polarizing plates 12 or 112 may be altered where appropriate. Alternatively, polarizing plate without the retardation functions may be used.

(4) The structural members are not limited to those having the light blocking properties. The technology described herein may be applied to structural members having light transmitting properties. At least sections of the electric lines 20 in the second embodiment may be prepared from a single layer of the transparent electrode film or a single layer of a metal mesh film to have the light transmitting properties. The at least sections of the electric lines 20 may have a multilayer structure of the transparent electrode film and the metal mesh film.

(5) The Light transmissive fixing layers 14 and 114 may he made of light curing resin that is curable by light in a wavelength range other than the ultraviolet ray, for example, visible light. The light transmissive fixing layers 14 and 114 may be made of thermosetting resin.

(6) The frame-shaped light blocking member may be disposed to partially overlap the front polarizing plate 112 along the perimeter of the front polarizing plate 112.

(7) The arrangement or the number of the electric lines 20 in the outer edge section of the cover glass 113 in the second embodiment may be altered where appropriate. For example, only the innermost electric line 20 may overlap the front polarizing plate 112. The electric lines 20 may extend the entire perimeter of the outer edge section of the cover glass 113.

(8) The touch panel pattern may be prepared from a metal mesh film.

(9) The frame-shaped light blocking member 15 in the first embodiment may be formed on the cover glass 113. In this case, the electric lines 20 and the frame-shaped light blocking member 15 may be referred to as the structural members in the second embodiment.

(10) The technology described herein may be applied to mutual capacitance type touch panel patterns. The technology described herein may be applied to touch electrodes having two dimensional shapes other than the diamond shape including rectangular shaped, round shapes, pentagonal shapes, and polygonal shapes other than the pentagonal shapes.

(11) The glass materials of the CF substrate 11A, the array substrate 11B, and the cover glasses 13 and 113 may be altered where appropriate. The CF substrate 11A, the array substrate 11B, and the cover glasses 13 and 113 may be made of material other than glass (e.g., synthetic resin).

(12) The liquid crystal panels 11 and 111 may be configured to operate in FFS mode, TN mode, VA mode, or RTN mode.

(13) The two dimensional shape of the liquid crystal display devices 10, 110 (and the liquid crystal panels 11 and 111 or the backlight unit EL) may be altered to vertically-long rectangular shapes, square shapes, oval shapes, elliptical shapes, round shapes, trapezoidal shapes, or shapes including curves.

(14) The technology described herein may be applied to other types of display panels such as organic EL panels, micro capsule type electrophoretic display (EPD) panels, and micro electro mechanical systems (MEMS) display panels.

1. A display device comprising:
a display panel for display images;
a polarizing plate fixed to the display panel;
a protective panel disposed such that the polarizing plate is sandwiched between the display panel and the protective panel;
a structural member projecting from a plate surface of the protective panel on a polarizing plate side and overlapping the polarizing plate; and
a light transmissive fixing layer disposed between the polarizing plate and the protective panel to fix the polarizing plate and the protective panel together, the light transmissive fixing layer being separated from the structural member with a clearance.

2. The display device according to claim 1, wherein the clearance between the light transmissive fixing layer and the structural member is equal to 0.1 mm or greater.

3. The display device according to claim 1, wherein the light transmissive fixing layer is disposed not to overlap the structural member.

4. The display device according to claim 3, wherein
the display panel includes a display area in which the images are displayed, and
the light transmissive fixing layer is disposed such that the clearance between the light transmissive fixing layer and the structural member is less than a distance between the structural member and the display area.

5. The display device according to claim 4, wherein the light transmissive fixing layer is disposed such that a difference between the clearance between the light transmissive fixing layer and the structural member and the distance between the structural member and the display area is greater than 0.1 mm.

6. The display device according to claim 1, wherein
the display panel comprises:
a pair of substrates;
a liquid crystal layer sandwiched between the substrates; and
a sealant disposed between the substrates to surround the liquid crystal layer and sealing the liquid crystal layer, the sealant being disposed such that an inner edge of the sealant is outer than an inner edge of the structural member.

7. The display device according to claim 1, wherein
the display panel, the polarizing plate, and the protective plate have elongated shapes, and
the structural member overlaps at least ends of the polarizing plate.

8. The display device according to claim 7, wherein the structural member overlaps the outer edge section of the polarizing plate for an entire perimeter of the polarizing plate.

9. The display device according to claim 1, wherein the structural member is a frame-shaped light blocking member having a light blocking property and being disposed in the outer edge section of the protective panel for an entire perimeter of the protective panel.

10. The display device according to claim 1, wherein the structural member is an electric line routed on the protective panel.

11. The display device according to claim 10, wherein
the protective panel includes a position detection electrode connected to the electric line for forming a capacitor between a conductive body for position input and the position detection and for detecting a position of input by the conductive body,
the position detection electrode is prepared from a transparent electrode film, and
the electric line a multilayer structure of the transparent electrode film and a metal film.

12. The display device according to claim 1, wherein the polarizing plate has a retardation function.
